(19) United States
(12) Patent Application Publication
(10) Pub. No.: US 2003/0139199 A1
(43) Pub. Date: Jul. 24, 2003

(54) Method for manufacturing a customized product, and customized product

(76) Inventors: Atte Kinnula, Kempele (FI); Jari Paloniemi, Flower Mound, TX (US); Tapani Ryhanen, Helsinki (FI); Jarmo Hietanen, Espoo (FI)

Correspondence Address: HARRINGTON & SMITH, LLP, 4 RESEARCH DRIVE, SHELTON, CT, 06484-6212, US

(21) Appl. No.: 10/322,324

(22) Filed: Dec. 18, 2002

(30) Foreign Application Priority Data
Dec. 31, 2001 (FI) 20012594

(51) Int. Cl. H04B 1/38

(52) U.S. Cl. 455/550; 455/575

(57) ABSTRACT

The invention relates to a method for manufacturing a cellular phone (200), and to a cellular phone manufactured using said method. In the manufacturing method according to the invention, the platform, which comprises the essential electronic components of the cellular phone, is manufactured using mass production technology. A working cellular phone (200) also includes electronic custom parts which are integrated in a structural element in the phone. A customer can modify the properties of his phone by replacing the structural element with another one which comprises different components. A custom part may also be changed by the customer himself.

The invention relates to a cellular phone manufacturing method for manufacturing a customized cellular phone, in which method the platform which comprises the central functions of the cellular phone is manufactured by means of mass production. The invention relates to a cellular phone manufactured using said manufacturing method.

In the manufacture of products we can discern two production sectors which operate on different principles. First, there is the so-called mass production where the goal is to manufacture a great volume of identical products for sale. The products have to be as uniform as possible, at least as regards components with high manufacturing costs. Only a limited number of product versions are designed and manufactured. Each product version requires a specially set up production line. High volumes, however, help bring down the production costs so that the manufacturing cost of a product will be reduced with time. Mass market will, however, invite competing imitations, which usually are sold at a lower price than the original product. Usually these imitations do not possess properties different from the original product. The principal means of competition is thus the price, and the price can be brought down by reducing the manufacturing costs through mass production and outsourcing.

The second production sector involves the manufacture of customer-specific, or customized, products. Each customer will receive an individual product which is specifically designed or at least fabricated according to the customer's wishes. This line of production deals with hand-made, unique products. The price of such a product is naturally high compared to a mass-made product.

Between these two extremes, there is a production sector called mass customizing. In that sector the aim is to make use of the benefits of mass production and yet be able to produce, on a large scale, products that can be customized to a certain level. In this production sector, the most expensive components of a product are series manufactured if possible. Some cheaper elements, however, are attached to the basic product from a finite selection of add-on modules. In the automobile industry, for example, it is in principle possible that a customer may design a new car for himself from existing optional components which will then be assembled into a custom car at the production line.

These same manufacturing alternatives are applicable to telephones intended to be used in cellular networks. There are inexpensive models for the mass market, nearly identical at least as regards their technical characteristics. In many countries the mobile phone market is still growing rapidly. There is thus still demand for mass-produced phones.

It is, however, predictable that as mobile phone coverage nears 100%, the basic phone with its properties is not enough. At some point consumers will be wanting to buy phones more and more tailored to their specific needs. Unique hand-made products are, however, too expensive for that purpose. Therefore, their market, measured by quantity, remains too small for large operators in the business to adopt this line of production.

In mobile phones there are already available some properties variable through mass customizing. Examples of these include removable color shells for phones, and batteries of different sizes. In addition, a user can, to a certain extent, acquire software applications for his device in order to personalize it so that it differs from other devices. However, mobile phone market lacks a manufacturing method to realize customer-specific mass tailoring on a large scale.

An object of this invention is to provide a new cellular phone manufacturing method to combine the benefits of both mass production and custom production.

The objects of the invention are achieved by a manufacturing method in which a cellular phone is assembled from three principal modules: a series-manufactured platform containing the core electronic components of the phone, custom components, and an interfacing element to make the two function as a whole.

A method according to the invention for manufacturing a cellular phone is characterized in that it comprises a step for mass-manufacturing at least one custom part, which includes electronic components, as part of a structural element of a phone, and a step for assembling the phone by combining a platform and at least one custom part into a functioning phone through the use of an interfacing means.

A cellular phone according to the invention is characterized in that the platform and the custom parts of the cellular phone are arranged so as to be manufactured as separate components which are arranged so as to be combined through interfacing means into a customized phone.

Preferred embodiments of the invention are presented in the dependent claims.

The idea of the invention is basically as follows: A cellular phone is manufactured from two main elements, a platform and a custom part, using an interfacing part which combines these two elements together. The platform which comprises the essential electronic components of the phone is mass-manufactured and can be used in the majority of a given manufacturer's products. It is therefore a good idea to integrate therein all the expensive parts the relative costs of which per phone can be reduced through mass production. Likewise it is a good idea to include therein all the parts and sensors which are needed in all or at least in as many product models from the manufacturer as possible. The phone is customized using a customer-specific part with various integrated active and passive components and various optional sensor combinations. The custom part is attached to the phone platform either at the last stage of production or possibly at a retail store or even by the customer himself. Such custom parts with integrated customer-specific electronic components include e.g. replaceable shells, battery, display, or keypad. In the method according to the invention, various sensors are included in these custom parts. A customer may acquire a plurality of different custom parts. Thus a customer may in one phone use a custom part with an integrated GPS positioning device, for example. In some other situation this custom part with the GPS functionality will be replaced by another part having e.g. a large memory block used e.g. to process documents or pictures on the phone or in some other device connected thereto.

An advantage of the invention is that in the manufacturing of a cellular phone it is possible to simultaneously gain from the benefits of both mass production and custom production.

Another advantage of the invention is that small quantities of phones can be manufactured in a profitable manner according to the JOT philosophy.

A further advantage of the invention is that the manufacture and launching into the market of new product prototypes will be quicker.

A yet further advantage of the invention is that a customer may himself modify a phone according to his needs, also after the purchase.

The invention will be now described in detail. In the description, reference will be made to the accompanying drawings, where

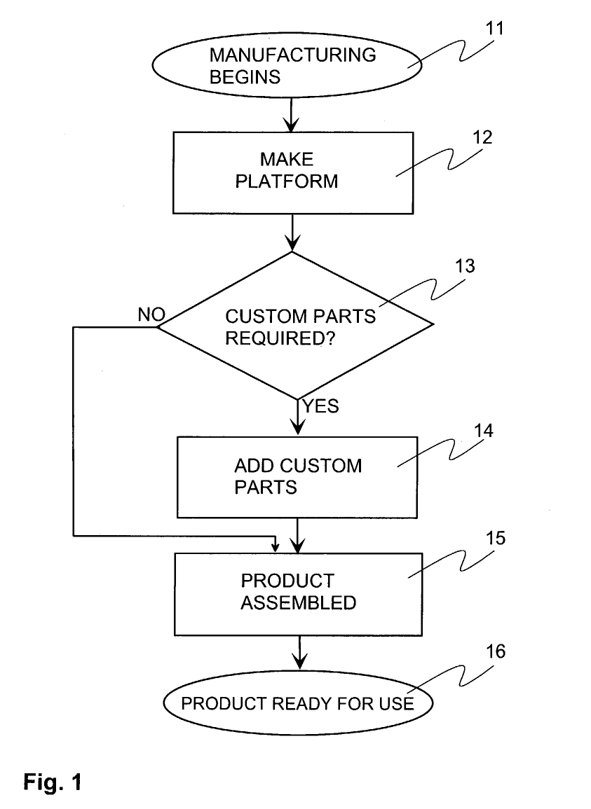

FIG. 1 shows as an example the main stages of the manufacture of a cellular phone according to the invention,

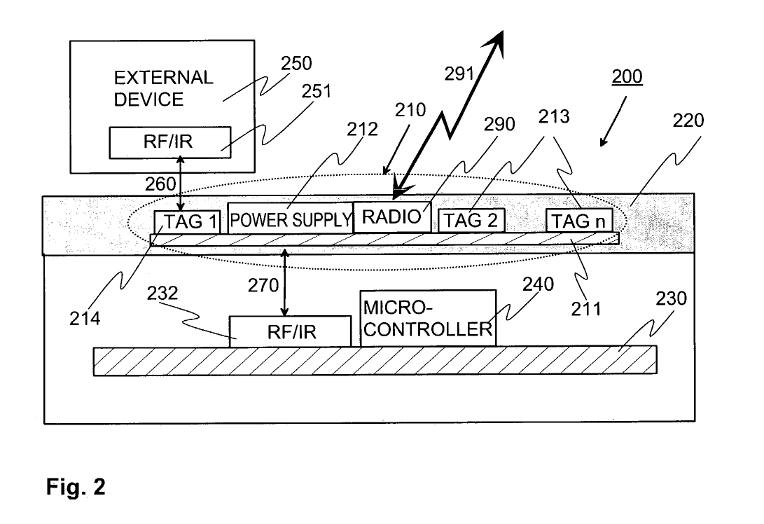

FIG. 2 shows as an example the main structural components of a cellular phone according to the invention,

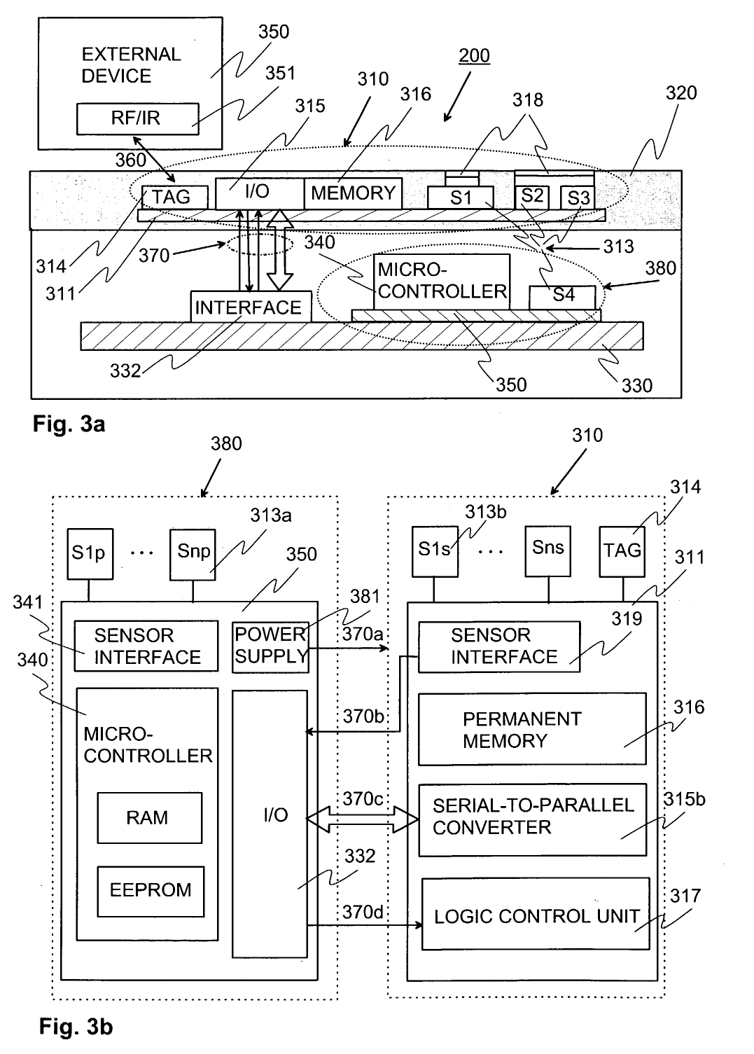

FIG. 3a shows as an example the main structural components of a cellular phone according to a second embodiment of the invention,

FIG. 3b shows as an example a functional block diagram of an embodiment according to FIG. 3a,

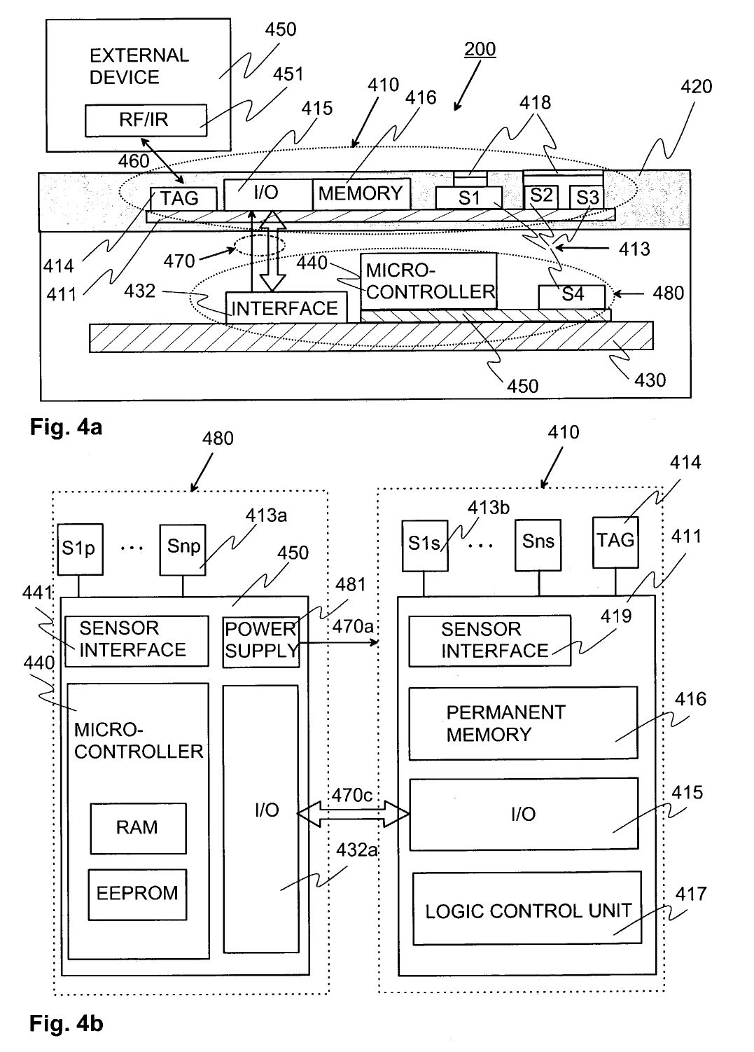

FIG. 4a shows as an example the main structural components of a cellular phone according to a third embodiment of the invention,

FIG. 4b shows as an example a functional block diagram of an embodiment according to FIG. 4a,

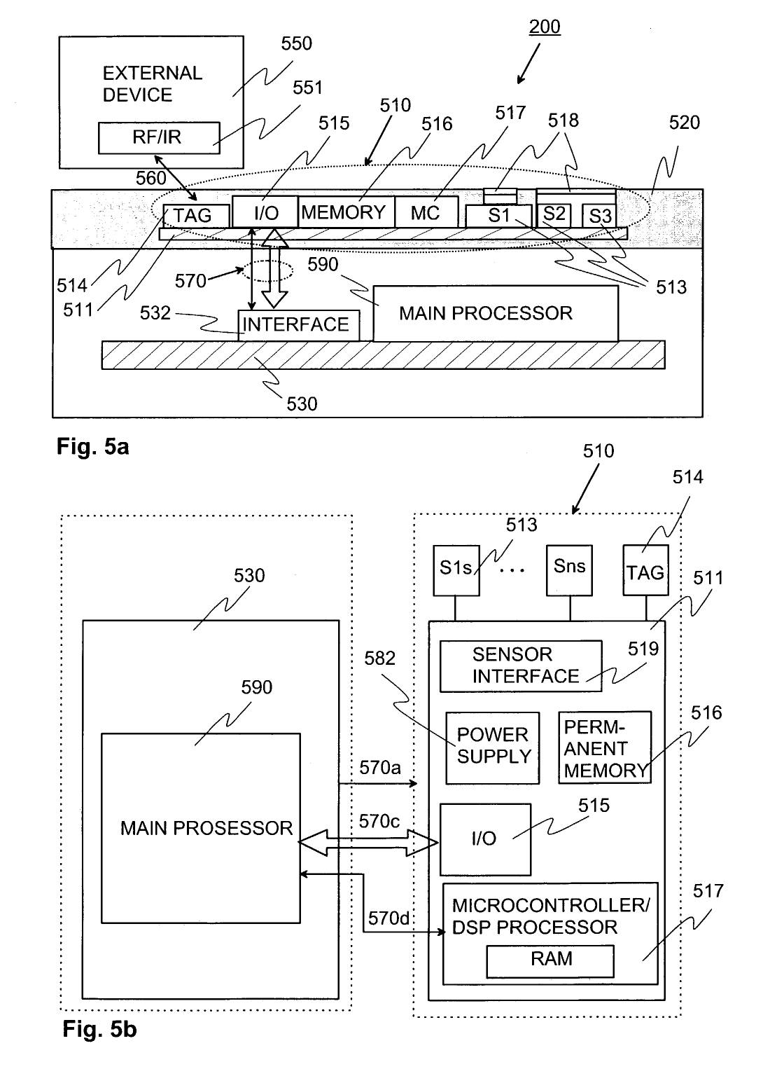

FIG. 5a shows as an example the main structural components of a cellular phone according to a fourth embodiment of the invention, and

FIG. 5b shows as an example a functional block diagram of an embodiment according to FIG. 4a.

Based on the explanatory illustrations provided by FIGS. 1 to 5 there is below described the main stages of the manufacturing process according to the invention and examples of phone structures according to the invention.

FIG. 1 shows as an example a flow diagram of the main stages of a manufacturing process for manufacturing a customized cellular phone according to the invention. Manufacture of the product begins at step 11 where the properties and functional blocks required by the customer are known.

The manufacturing process starts from step 12 in which the platform of the product is manufactured, which platform advantageously comprises the main electronic components of the phone and the mechanical components utilized in most of the cellular phone models. The electronic and possible mechanical components are advantageously attached to a separate printed circuit board. Naturally, the main electronic functions may also be integrated into a single application-specific integrated circuit (ASIC) which is either attached to a separate printed circuit board or it may comprise connecting means for connecting the ASIC so as to form part of some other functional block of the phone. Sensors utilized in most of the phone models are also attached to the platform. Such sensors include e.g. the microphone and earphone. Advantageously at this stage the platform is attached to such part of the body of the phone that it is protected against mechanical damage at later manufacturing stages. The platform can thus be manufactured using mass production technology whereby it is possible to minimize the platform production costs. This part of the production process is always done at the production plant proper.

The next stages of the production process can be done either at the production plant proper or at the wholesale or retail stage, for instance, or by the customer himself. If the product is completely made at the production plant, the customer may participate in the manufacturing process via various communication networks.

Regardless of the place of the final assembly of the phone, step 13 in FIG. 1 comprises a check for whether custom parts are needed. If so, it is at the same time determined what kind of a custom part should be installed in the customer's phone in addition to the standard platform.

A custom part advantageously comprises various electronic components and various sensors required by the customer. Such sensors may be, for example, devices that monitor and report the activities of the user of the phone. Likewise, sensors can be used to monitor the surroundings of the user and changes therein. In addition to said sensors a custom part may comprise various electronic components such as microprocessors, memories and power supplies. The electronic parts may also be integrated in a single ASIC circuit. These electronic parts and sensors are advantageously attached to a discrete printed circuit board. Furthermore, a custom part comprises a means attached to the circuit board to enable data communication between the custom part and the platform which realizes the core functions of the phone. A custom part is integrated in a component of the phone e.g. by placing it within an injection-molded plastic part. Such a custom part comprising said components and sensors may be e.g. part of the shell of the phone, display, battery, or the keyboard of the phone. There may be a plurality of custom parts in a single cellular phone manufactured. These custom parts of a cellular phone can be manufactured using mass production technology, whereby their manufacturing costs will remain low.

In step 14 the body of the phone, which comprises the platform, and the custom parts and other parts of the phone's shell are assembled into a complete cellular phone. This may take place at the production line, at the wholesale or retail stage or it may even be done by the customer himself. In the latter case the customer can always customize his phone according to his current needs. Thus in step 15 the phone has been assembled is ready for use in step 16.

In the manner described above it is possible to use the manufacturing process according to the invention to fabricate a customized cellular phone the manufacturing costs of which can be kept reasonably low. Moreover, it is possible to increase the number of different product versions without having to build new specialized product lines. Furthermore, the customer is able to modify his phone after the purchase, using other custom parts, so that the phone is always in accordance with his current needs.

FIGS. 2 to 5b illustrate, as examples, a few advantageous embodiments of a cellular phone manufactured using the manufacturing process according to the invention. The custom part is not explicitly specified in FIGS. 2 to 5b, but advantageously it is part of the phone's shell, the battery, display or keyboard. Furthermore, it should be noted that even though just one custom part is shown in the figures, the phone may also comprise several custom parts.

FIG. 2 shows, by way of example, some main components of a phone 200 according to an embodiment of the invention. FIG. 2 does not show all the structural elements of a functioning phone 200. The mass-produced platform of the phone which comprises the essential electronic components is assembled on a first printed circuit board 230. Advantageously the platform comprises at least a microcontroller 240 and an interface component 232. The interface component 232 comprises a means for providing an infrared or radio link 270 between the platform and the custom part 210.

In the embodiment according to FIG. 2 the custom part 210 comprises a plurality of tags which may be either active 214 or passive 213. An example of an active tag is the radio frequency identity (RFID) tag according to ISO 14443. If active tags are used, the custom part advantageously also comprises a separate power supply 212 such as a battery. The custom part 210 may also comprise a short-range radio device 290 to provide a radio path 291 to an external device. Such a connection may comprise a Bluetooth link or an inductive reader link according to ISO 14443.

The components described above are attached to a separate printed circuit board 211. The complete printed circuit board is integrated so as to form part of a structural element of the phone e.g. by leaving it inside an injection-molded plastic component 220. Active tags 214 use a special response signal to respond to an input signal 260 sent by transmitter means 251 in an external device 250. The tags 213, 214 and potential power supply on the printed circuit board 211 are integrated into a structural element 220 of the phone 200. Such a structural element 220 may be e.g. part of the phone's 200 shell, a battery, display or keyboard.

A cellular phone according to FIG. 2 is thus assembled using a mass-produced platform, which advantageously comprises a microcontroller 240 and interface means 232 on a printed circuit board 230, and a custom part 220 which comprises integrated tags required by the customer. In operating mode, the data communication between the platform and custom part in the phone is realized using a wireless link 270.

FIGS. 3a and 3b show, as examples, main components of a cellular phone according to a second embodiment of the invention and the functional block diagram thereof. In this embodiment the platform 380, which comprises the essential electronic components of the phone, is connected, in a fixed manner, to a custom part 310 in a structural part 320. The interface 370 advantageously comprises the following separate connections between the platform 380 and custom part 310: power supply 370a to the custom part, signaling line 370b to the sensor interface unit 319 in the custom part 310, a serial bus 370c which may be e.g. I2C or SPI, and a control signaling line 370d.

In accordance with FIGS. 3a and 3b the platform 380 advantageously comprises a microcontroller 340 and at least one separate sensor 313, sensor S4. Sensor S4 is of such a type that it is used in all the different product versions of the phone. Sensor S4 and microcontroller 340 are series-manufactured on a first printed circuit board 350. The microcontroller 340 comprises the necessary amount of RAM (random access memory) and permanent memory such as EEPROM (electrically erasable programmable read-only memory) or FLASH. The platform may also comprise a power supply 381, other sensors 313a, sensor interface 341 and an I/O port in the interface means 332. The first printed circuit board 350 is connected to a second printed circuit board 330 to which the interface means 332 required by the structure according to the invention are connected.

The custom part 310 advantageously comprises an interface unit 315 which is advantageously a serial-to-parallel converter 315b. In addition, the interface unit 315 comprises case-specific interface electronics and physical connectors for providing a connection 370. The custom part 310 further comprises an advantageously permanent memory 316, EEPROM or FLASH, a logic control unit 317, at least one tag 314, and a number of separate sensors S1, S2, S3, reference designators 313, 313b. Said components are connected to a third printed circuit board 311. When the third printed circuit board 311 with its components is integrated as part of a structural element 320 of the phone, at least part of the interface means 315 must be located on the surface of the structural element 320 so that the physical connection 370 with the platform 380 can be realized. The structural element 320 of the phone is advantageously made of injection-molded plastic.

The tag 314 reacts to an input signal 360 sent by transmitter means 351 in an external device 350. If necessary, the tag 314 sends out a response signal.

The sensors 313 integrated in the custom part 310 communicate with their environment through apertures in part 320 and covers 318 which at least partly protect them. The covers may protect the sensors mechanically, chemically or optically. The sensors may also be actuators of various kinds, such as vibrators, speakers, light effect devices, cameras.

FIGS. 4a and 4b show, as examples, main components of a cellular phone according to a third embodiment of the invention and the functional block diagram thereof. In this embodiment, too, the platform 480, which comprises the essential electronic components of the phone, is connected through a fixed connection 470 to a structural element 420 of the phone 200 which includes a custom part 410. The connection 470 advantageously comprises a power supply 470a to the custom part and a serial bus 470c through which the main components of the phone communicate with each other.

In accordance with FIGS. 4a and 4b the platform 480 advantageously comprises a microcontroller 440 and at least one separate sensor 413, sensor S4. Sensor S4 is of such a type that it is used in all the different product versions of the phone. Sensor S4 and microcontroller 440 are series-manufactured on a first printed circuit board 450. The microcontroller 440 comprises the necessary amount of RAM and permanent memory such as EEPROM or FLASH. The platform advantageously also comprises a power supply 481, other sensors 413a, sensor interface 441 and an interface means which includes an I/O port 432a. The first printed circuit board 450 is connected to a second printed circuit board 430 to which the interface means 432 required by the structure according to the invention is connected.

The custom part 410 advantageously comprises a connecting means 415 which comprises an application-specific electronic part and physical connectors for providing a connection 470. The custom part 410 further comprises a permanent memory 416, advantageously of type EEPROM or FLASH, a logic control unit 417, at least one tag 414, and a number of separate sensors S1, S2, S3, reference designators 413, 413b. Said components are connected to a third printed circuit board 411 which is integrated as part of a structural element 420 of the phone by leaving it inside an injection-molded plastic part. At least part of the connecting means 415, i.e. the physical connectors, must extend to the surface of the structural element 420 of the phone so that the physical connection 470 with the platform 480 can be realized.

The tag 414 reacts to an input signal 460 sent by transmitter means 451 in an external device 450. The signal is advantageously an infrared or radio signal. If necessary, the tag 414 sends out a response signal.

The sensors 413 integrated in the custom part 410 communicate with their environment through apertures in part 420 and covers 418 which at least partly protect the sensors. The covers may protect the sensors mechanically, chemically or optically. The sensors may also be actuators of various kinds, such as vibrators, speakers, light effect devices, cameras.

FIGS. 5a and 5b show, as examples, main components of a cellular phone according to a fourth embodiment of the invention and the functional block diagram thereof. In this embodiment the platform advantageously comprises a main processor 590 which is connected to a second printed circuit board 530. To that same printed circuit board 530 there is also connected an interface means 532 via which it is possible to connect a separate power supply connection 570a and a parallel data bus 570c, say IEEE P14152, to the custom part 510.

In accordance with FIGS. 5a and 5b the platform of the cellular phone 200 comprises a main processor 590 and a second printed circuit board 530 connected thereto. The main processor 590 advantageously further comprises a sufficient amount of RAM and permanent memory such as EEPROM or FLASH in order to store and run the application programs used by the phone 200. The main processor 590 is connected via a serial bus 570c to the means according to the invention located in the custom part 510. In addition, a microcontroller 517 in the custom part can send interrupt requests to the main processor 590 through a separate connection 570d. The power needed by custom part 510 is supplied via connection 570a from the platform 530.

The custom part 510 advantageously comprises a microcontroller or a digital signal processor (DSP) 517 with RAM, a power supply 582, interface means comprising an I/O port 515 and physical connectors. In addition, the custom part 510 comprises a non-volatile memory 516, such as EEPROM or FLASH, at least one tag 514 and a number of separate sensors S1, S2, S3, denoted by reference designator 513. Said components are connected to a third printed circuit board 511 which is integrated as part of a structural element 520 of the phone.

The tag 514 reacts to an input signal 560 sent by transmitter means 551 in an external device 550. If necessary, the tag 514 sends out a response signal.

The sensors 513 integrated in the custom part 510 communicate with their environment through apertures in element 520 and covers 518 which at least partly protect the sensors. These covers may protect the sensors mechanically, chemically or optically. The sensors may also be actuators of various kinds, such as vibrators, speakers, light effect devices, cameras.

FIGS. 2 to 5 show some cellular phone 200 structures complying with the manufacturing method according to the invention, mainly for those parts to which the method according to the invention is applicable. The examples presented do not include all cellular phone 200 parts to which the invention is applicable. Moreover, a given phone may comprise a plurality of structural elements that include custom parts. In the examples illustrated, the platform, which comprises the essential electronic components of the phone, is always manufactured identical for all versions of the manufacturer's phone. This results in cost savings associated with mass production. The custom parts 210, 310, 410, 510 may also be manufactured in large series. However, all parts have physical dimensions such that they can be fitted together even by the user.

Some exemplary embodiments of the invention were described above. The invention is not limited to the embodiments described. The inventional idea can be applied in numerous ways within the scope defined by the claims attached hereto.

1. A cellular phone manufacturing method for manufacturing a customized cellular phone, in which method the platform comprising the central electronic functions of the cellular phone is manufactured by means of mass production, wherein the manufacturing method further comprises
a step for mass-manufacturing at least one custom part, which includes electronic components, as part of a structural mechanical component of the phone, and
a step for assembling the phone by combining the platform and at least one custom part into a functioning phone through the use of an interfacing means.

2. A method according to claim 1 wherein the components belonging to a custom part are connected to a printed circuit board, which is integrated as part of a structural mechanical component of the phone.

3. A method according to claim 2 wherein at least one tag is attached to a printed circuit board in conjunction with the manufacture of the custom part.

4. A method according to claim 2 wherein at least one sensor is attached to a printed circuit board in conjunction with the manufacture of the custom part.

5. A method according to claim 2 wherein at least one electronic component is attached to a printed circuit board in conjunction with the manufacture of the custom part, which component is one of the following: microcontroller, DSP processor, logic control unit, I/O port, permanent memory, means for establishing a short-range radio link.

6. A method according to claim 1 wherein the assembly of the phone is done by the customer by connecting together the platform of the phone, which is attached to a part of the body of the phone, and at least one structural mechanical component of the phone that comprises a custom part.

7. A cellular phone including a mass-produced platform which comprises central electronic functions of the phone and is to be attached to a structural mechanical component of the cellular phone, and at least one custom part in which phone the platform and custom parts of the phone are arranged so as to be manufactured as separate components which are to be combined through an interfacing means into a customized phone.

8. A cellular phone according to claim 7 wherein the platform comprises a printed circuit board with a microcontroller connected thereto, and connecting means for combining the platform and the custom part into a working whole.

9. A cellular phone according to claim 8 wherein the platform further comprises at least one sensor.

10. A cellular phone according to claim 8 wherein the interfacing means are arranged so as to enable the establishment of a connection with one of the following modes of connection between the platform and a custom part, an infrared link, an induction link, a radio link, a power supply line, a serial bus, IEEE P14512 parallel bus.

11. A cellular phone according to claim 7 wherein the custom part, which includes electronic components, is integrated as part of a structural mechanical component of the phone.

12. A cellular phone according to claim 11 wherein the custom part is arranged so as to be located inside an injection-molded part of the phone.

13. A cellular phone according to claim 11 wherein the structural mechanical component of the phone is one of the following: a battery of the phone, a display, a keyboard, a part of the phone's shell.

14. A cellular phone according to claim 11 wherein the custom part comprises at least one of the following electrical components: microcontroller, DSP processor, at least one tag, I/O means, EEPROM memory, FLASH memory, at least one sensor, power supply, means for establishing a short-range radio link.
